(19) United States
(12) Patent Application Publication
(10) Pub. No.: US 2011/0117983 A1
(43) Pub. Date: May 19, 2011

(54) Method and apparatus for varying win probability and payouts of a gaming machine

(76) Inventor: Charles Lombardo, Pembroke Pines, FL (US)

(21) Appl. No.: 12/931,127

(22) Filed: Jan. 24, 2011

Related U.S. Application Data
(63) Continuation of application No. 12/283,787, filed on Sep. 15, 2008, now abandoned.
Application No. 12/283,787 is a continuation of application No. 10/392,449, filed on Mar. 18, 2003, now abandoned.

(51) Int. Cl. G06F 17/00

(52) U.S. Cl. 463/16

(57) ABSTRACT

A method and apparatus for varying win probabilities and/or payouts of a gaming machine as a function of the amount wagered by a player in a round of play is disclosed. In one embodiment, the probability of receiving a winning combination and/or the payouts for one or more winning combinations increase as an amount wagered increases. In one embodiment, sets of outcomes are stored in memory, each set of outcomes associated with an amount bet or a range of bets. The possible outcomes for larger bets represent a higher probability of receiving a winning combination or payout. The outcome of a game or round is determined by mapping a random number generated by a random number generator to outcomes stored in memory.

### RELATED APPLICATION DATA

This application is a continuation of U.S. patent application Ser. No. 12/283,787, filed Sep. 15, 2008, which is a continuation of U.S. patent application Ser. No. 10/392,449, filed Mar. 18, 2003.

### FIELD OF THE INVENTION

The present invention relates to a method and apparatus for varying the win probability and/or payouts of a gaming machine based on the amount wagered by a bettor.

### BACKGROUND OF THE INVENTION

Gaming is an increasingly popular activity. Over the years, a variety of new gaming devices and games have been developed. Generally, casinos seek new games and gaming devices which entice players to play more frequently, since this increases the revenue to the casino. Players seek new games and gaming devices which are more entertaining and which the player believes has an increased probability of resulting in a win.

One of the most popular of gaming machines is the slot machine. Slot machines were originally mechanically controlled, where the reels were made to spin about an axis by the rotational momentum exerted by the pull of its handle. The angular position of the reels determined the nature of the symbols or the outcome and determined whether a bettor received a winning outcome and an associated payout.

A variety of modifications to the slot machine have been introduced over the years. Now, the reels of slot machines are electronically controlled. In other instances, the reels have been eliminated altogether, the reels simulated in video form on one or more video displays.

Other features have been added to slot and other gaming machines. Current gaming machines utilize video monitors having higher screen resolutions and color depth. Audio has gone from a mono speaker to stereo surround sound. These improvements provide for an increased level of entertainment from the perspective of the player.

A variety of features have been introduced to entice new players to play gaming machines or to cause existing players to play more frequently. For example, bonus games have been added to existing games. The games may also be configured to award large jackpots for certain winning combinations.

Many gaming machines have been configured to accept bets of different sizes. Casinos generally desire that a player bet as large a wager as possible, as such generally increases the revenue of the casino. As one example, a slot machine may be configured to accept a bet comprising one, two or three coins of a particular denomination. As is known, these slot machines are configured to pay winning amounts which are an integer multiplier of the number of bets or coins wagered. For example, when two coins are inserted for play, the payout is simply twice the payout for a winning outcome when a single coin is bet. Likewise, when a maximum number of coins (3 coins usually) are played, the payout is generally three times the base payout. In order to entice a player to place the maximum bet, a jackpot amount may only be awarded for receiving a particular winning combination when the player places the maximum bet.

In this arrangement, there is little or no incentive for a player to increase the number of coins or bets wagered in a round of play. The only instance in which a bettor may increase his bet to the maximum is when he feels that the jackpot is at a level that warrants an increased bet. In all other cases, the bettor may simply bet the minimum amount per round of play.

An improved method and apparatus for gaming machines that attracts a larger number of bettors, maximizes the amount wagered per round of play, and generates increased gaming revenue is desired.

### SUMMARY OF THE INVENTION

One aspect of the invention is a method of playing a game on a gaming machine where the probability of receiving a winning outcome varies as bet size varies, and/or a method of playing a game in which the average payout varies. Other aspects of the invention are a gaming machine configured to implement one or more methods of the invention.

One embodiment of the invention is a method of playing a game on a gaming machine in which the probability of receiving a winning outcome varies dependent upon an amount wagered. In one embodiment, this method includes the step of accepting a wager from a player. The method also includes the step of determining if the wager is a first amount or a second amount, the second amount being larger than the first amount. A game is presented for play by the player, the game having a first probability of resulting in a winning outcome if the wager is the first amount, and the game having a second probability of resulting in a winning outcome if the wager is the second amount. The method further includes the steps of determining the outcome of the game and awarding the player a winning if the outcome is a winning outcome.

In one embodiment of this method, the second probability is greater than the first probability. In other words, the probability of receiving a winning outcome increases when a larger bet is placed.

In one embodiment, the method includes the step of providing groups of outcomes and selecting a particular group of outcomes based upon the amount wagered by the player, the group of outcomes selected from a set of at least two groups of outcomes associated with wagers of different amounts, each group of outcomes representing a different probability of receiving a winning outcome.

In one embodiment, groups of outcomes are stored in a memory. Each outcome of a group of outcomes is identified by a number. The method includes the step of generating a random number and mapping that number to a particular outcome of the selected group of outcomes.

Another embodiment of the invention comprises a method of playing a game on a gaming machine in which the payout for game play varies dependent upon amount wagered. This method includes the steps of accepting a wager from a player and determining if the wager is a first amount or a second amount, the second amount being larger than the first amount. In one embodiment, the method further includes the step of presenting a game for play by the player, wherein an average payout for particular winning combinations received when the wager is the first amount varies from an average payout for the same winning combinations received when the wager is the second amount, preferably by more than the percentage difference between the first and second bets. The method further includes the steps of determining the outcome of the game and awarding the player a winning if the outcome is a winning outcome.

In another embodiment, the average payout over time for winning combinations received when the wager is the second amount is greater than the average payout over time for winning combinations received when the wager is the first amount by more than the percentage difference between the first and second bets.

In accordance with this embodiment, outcomes having associated payouts may again be stored in a memory and selected with a random number.

In one embodiment of a method of the invention, both the probability of receiving a winning outcome and the average payout may vary.

One or more embodiments of the invention comprise a gaming machine configured to present a method of the invention. The gaming machine may be of a variety of types and configured to present a variety of games, such as a video gaming machine configured to present video poker or a slot machine configured to present the game of slots.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a gaming machine in accordance with the present invention;

FIG. 2 illustrates one embodiment of a system of the gaming machine illustrated in FIG. 1 configured to implement a method of the invention;

FIG. 3 illustrates exemplary payouts for outcomes based on a minimum bet or wager;

FIG. 3A illustrates an exemplary set of outcomes and their associated payouts when a minimum bet is wagered;

FIG. 3B illustrates an exemplary set of outcomes and their associated payouts when twice the minimum bet is wagered;

FIG. 3C illustrates an exemplary set of outcomes and their associated payouts when three times the minimum bet is wagered;

FIG. 4 is an operational flowchart of an embodiment used to vary the win probability in a gaming machine;

FIG. 5 illustrates exemplary outcomes for a minimum wager in a gaming machine;

FIG. 5A illustrates an exemplary set of payouts when a minimum bet is wagered;

FIG. 5B illustrates an exemplary set of payouts when twice the minimum bet is wagered;

FIG. 5C illustrates an exemplary set of payouts when three times the minimum bet is wagered;

FIG. 6 is an operational flowchart of an embodiment used to vary the payouts of winning outcomes in a gaming machine.

FIG. 7 is an illustration of a second system used to vary the win probability or payout of a gaming machine;

FIG. 8A illustrates an exemplary set of outcomes that vary based on amount wagered;

FIG. 8B illustrates exemplary winning outcomes in a gaming machine;

FIG. 8C illustrates exemplary losing outcomes in a gaming machine;

FIG. 8D illustrates an exemplary set of payouts that vary based on the amount wagered;

FIG. 9 is an operational flowchart of an embodiment used to vary the percentage of winning outcomes and the amount of payout in a gaming machine.

FIGS. 10(a) and (b) are tables illustrating exemplary configurations for games in accordance with the invention; and

FIGS. 11(a), (b) and (c) are tables illustrating yet other exemplary configurations for games in accordance with the invention.

### DETAILED DESCRIPTION OF THE INVENTION

The invention is a method and apparatus to vary win probabilities and/or payouts of a gaming machine as a function of the amount wagered by a bettor in a round of play. The win probabilities and/or the payout(s) on winning outcome(s) may be adjusted higher as a bettor wagers a higher amount of money. It is anticipated that such incentives may encourage a bettor to wager a maximum amount, providing increased revenue for the casino operator and greater excitement for the bettor.

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The embodiments described incorporate a methodology that increases the win probability or payout for a particular game or a round of play of a gaming machine when a higher wager is placed. In accordance with the invention, a gaming machine is configured to accept a wager in the form of a coin, token, or credit. The gaming machine is configured to accept wagers of different amounts comprising multiples of a coin, token or credit. The probability of obtaining a winning out come, or the payout for a winning outcome, increases based upon the size of the bet.

One embodiment of the invention is method of playing a game on a gaming machine and a gaming machine which is configured so that the probability of the occurrence of a winning outcome increases as a player's wager increases. By “winning outcome” it is meant an outcome where the player is awarded an award, such as a payout of value. Preferably, the outcome is winning if the amount of the payout exceeds the player's bet.

One embodiment of the invention is a method of playing a game on a gaming machine and a gaming machine which is configured so that a payout or the average payout increases as a player's wager increases. By “average” payout, it is meant the statistical average return or payout for all outcomes, or at least all winning outcomes.

In another embodiment, the payout for at least one winning outcome increases as a player's wager increases. Preferably, the payout increases by a percentage which exceeds the percentage by which the player's wager increases or varies.

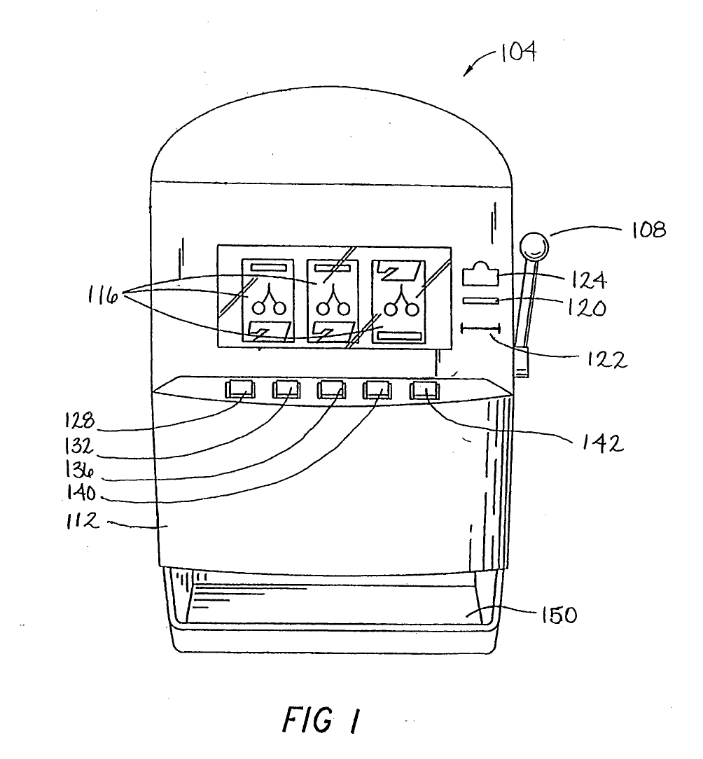

FIG. 1 illustrates one embodiment of a gaming machine 104 of the invention. This gaming machine 104 is similar in many respects to a typical gaming machine configured to present a game of slots. These gaming machines 104 may be situated in a casino or other establishment. It is contemplated that the gaming machine 104 of the invention may be configured to present a wide variety of games now known or later developed, including Blackjack or “21,” Poker and others, and may include other devices than that illustrated. For example, the gaming machine 104 may be configured not only as a “stand-up” unit, but may be configured as a bar-top unit. The gaming machine 104 may also comprise a computing device, such as a computer, and may comprise a distributed computing device, such as a player console connected to a remote server device.

In the embodiment illustrated, the gaming machine 104 comprises a structure having an arm 108 attached to a body or housing 112. The body 112 of the gaming machine 104 provides a view of three reels 116. The three reels 116 display symbols or indicia which represent the outcome of a game played on the gaming machine when a bettor makes a wager and initiates a round of play by pressing a spin reel button 142 or by pulling the arm 108 of the gaming machine 104.

The bettor makes a wager by inserting coins into a coin acceptor 120, by inserting bills into a bill acceptor 124, or by inserting a credit or debit type card or the like into a card acceptor 122. The card acceptor 122 allows a bettor to transfer funds from his account into the gaming machine. When credits have accumulated in the gaming machine 104, the bettor may wager a number of his credits by pressing a single bet button 136 once or a number of times up to a maximum bet. In other cases, the bettor may press a maximum play button 140 to wager a maximum allowable amount for the gaming machine 104. Other buttons that may be situated on the gaming machine 104 include a call attendant button 128 and a cash out button 132. The call attendant button 128 may be pressed when the bettor requires assistance from a casino employee concerning his gaming machine 104. The cash out button 132 may be pressed when the bettor wishes to dispense credits accumulated in the gaming machine 104 into coins or tokens. These coins or tokens may be dispensed into a coin or token collector 150 located near the bottom of the gaming machine 104.

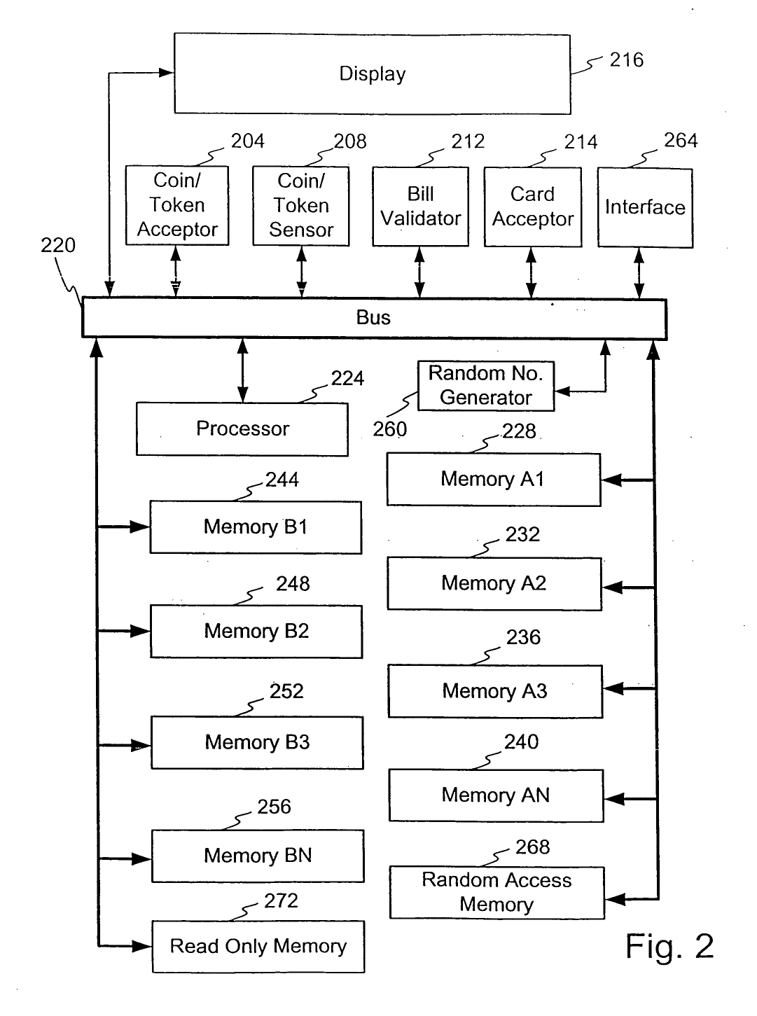

Means, such as a master gaming controller or control system, are used to control the operation of the gaming machine 104. FIG. 2 illustrates an embodiment of such a system or controller. As shown, a coin/token acceptor 204 accepts coins or tokens inserted by a bettor. The coin/token acceptor 204 may accept coins of one or more denominations. In other instances, tokens may be obtained in lieu of cash as provided in a casino. It is contemplated any number of coins or tokens may be accepted prior to a round of play. A coin/token sensor 208 senses the quantity of coins accepted prior to a round of play and provides this information to a processor 224 for processing. The processor 224 comprises a central processing unit that facilitates computations and logical functions within the gaming machine circuitry. The processor 224 may be a Pentium processor manufactured by Intel Corporation, an Athlon processor manufactured by AMD Corporation or any similar type processor.

The coin/token sensor 208 may act to verify or authenticate the coin/token deposited into the coin/token acceptor 204. The coin/token sensor 208 may also provide a signal indicating that a coin/token was successfully deposited into the coin/token acceptor 204. Information provided by the coin/token sensor 208 communicates to the processor 224 by way of a communication bus 220. The bus 220 acts as a high speed medium in which data may communicate between different functional devices within the gaming machine.

Similarly, a bill validator 212 provides acceptance of paper currency of different denominations. Upon the acceptance of paper currency, the bill validator 212 either dispenses tokens/coins or establishes a number of credits equivalent to the currency accepted. As a convenience to the player or bettor, a card acceptor 214 may accept a credit or debit type card, facilitating the transfer of funds from one's account into equivalent credits on the gaming machine.

The coin/token sensor 208, bill validator 212, and card acceptor 214 interact with the processor 224 to provide a cumulative total of the amount of credits accumulated for use by the bettor. The cumulative total may be stored in a random access memory 268. The random access memory 268 may store data related to the accounting history of a gaming machine. When coins or tokens are deposited into the gaming machine, the processor 224 increments the number of credits in the random access memory 268 accordingly.

Though not illustrated, other means may be provided for providing value to the gaming machine. For example, the gaming machine may include a credit, debit or smart card reader. The gaming machine may also include a ticket reader. Preferably, these devices also provide data to the processor 224 regarding credits or other value provided by the player.

When a round of play occurs, the processor 224 decrements the number of credits in the random access memory 268 by the amount bet or wagered. The number of credits may be displayed on a display 216 in an appropriate location on the body of the gaming machine. The display 216 will also serve to provide outcome information in the form of symbols or indicia recognizable to the bettor. The display 216 may comprise one or more monitors, a mechanical wheels, LCD displays, LED displays, or other devices and systems capable of providing visual information to a bettor.

In one embodiment, the size of the wager which is placed by the player is determined by a player's input. In one embodiment, this input is by depression of the single bet button or maximum play button.

In one embodiment, the processor 224 determines the location in a memory 228, 232, 236, 240 that will generate an appropriate set of outcomes as a function of the amount wagered when a round of play is initiated. The memory 228, 232, 236, 240 may comprise a single memory device or multiple memory devices, and may comprise ROM, RAM, EEPROM or a wide variety of other data storage devices.

In one embodiment, one or more memory devices store “look up” tables. These look up tables comprise sets of data which represent sets of possible outcomes. In one embodiment, each memory 228, 232, 236, 240 stores a separate set or table of outcomes. In accordance with the invention, a particular set or table of outcomes is chosen, and then a particular outcome is determined from that set or table.

In this embodiment, memory A1 228 stores a set or table of data representing the possible outcomes associated with a minimum, or first, wager, memory A2 232 stores a set or table of data representing the possible outcomes associated with a second wager that is larger than the first wager, such as twice the minimum wager, while memory A3 236 stores a set or table of data representing the possible outcomes associated with a third wager that is larger than the first or second wager, such as three times the minimum wager. It is contemplated that a gaming machine may have multi-denominational wagering capabilities where any multiple of a minimum wager is accepted by the gaming machine. In this instance, a memory AN 240 stores a set or table of data representing the possible outcomes associated with a wager that is N times the minimum wager. To encourage a player to wager a larger amount of money per round of play, it is contemplated that memory A3 236 stores a set or table of outcomes comprising more winning outcomes than that of memory A2 232, while memory A2 232 stores a set or table of outcomes comprising more winning outcomes than that of memory A1 228. It is contemplated that the number (or percentage) of winning outcomes stored in each memory 228, 232, 236, 240 can be varied to suit a gaming machine operator's preferences.

The set or table of data preferably defines the possible outcomes of the game or other event being played. In the game of slots, the outcomes are represented by symbols or indicia displayed by the reels or displayed on a video display. In one embodiment, the outcomes comprise a winning or losing outcome, and if a winning outcome, have a payout associated therewith. Each outcome, whether winning or losing, is represented by a set of symbols or data, the symbols or data used to visually present the outcome to the player.

In one embodiment, each possible outcome is associated with or corresponds to a specific number or numbers which may be generated by a random number generator (RNG) 260. As illustrated, the RNG 260 is an electronic device within the gaming machine capable of generating a random number.

As one example, in the game of slots, outcomes may be represented by combinations of the symbols red 7, white 7, blue 7, cherry, double, triple, single bar, double bar, triple bar, and blank. In a “three-reel” game, the outcome is represented by a combination of three of these symbols or indicia. Thus, in this example, a number generated from the RNG 260 may correspond to an outcome represented by the symbols red 7, white 7, and blue 7. In the case of other games, such as a game of video poker, a number generated by the RNG 260 may correspond to an outcome represented by symbols representing a royal flush (i.e., the cards A, K, Q, J, 10 of the same suit).

Based upon the number generated by the RNG 260, associated outcome information is used to define the outcome and display the outcome to the player. For example, in the case of a slot machine, the reels are stopped in a position so that they display the symbols which represent the outcome. In the case of a video poker machine, images of cards are displayed. In this manner, a player may determine whether an outcome in a round of play is a winning outcome.

If the outcome is a winning outcome, other actions are preferably triggered. For example, in the event of a winning outcome, a winning payout is preferably awarded to the player. This award may be in the form of credits, coins or the like. As is also known, in the event of a winning outcome, an audible notification of the win may be provided, such as by the sounding of bells or other sounds.

In another embodiment of the invention, the gaming machine's payouts (as opposed to percentage of winning outcomes) may be varied as a function of the amount wagered by a player during a round of play. In one variation or implementation of this embodiment, the payout associated with one or more particular winning outcomes varies based upon the size of the bet. Preferably, the size of the average payout associated with one or more particular winning outcomes increases by more than an increase in the size of the bet. In another variation or implementation of this embodiment, the average payout or machine “return” varies based upon the size of the bet. Preferably, the average payout or return increases as the size of the bet increases.

Aspects of the first variation of this embodiment will now be described. As was described previously, a RNG 260 generates a random number that corresponds to an outcome during a round of play. In this variation, however, the probability of receiving each possible outcome (whether winning or losing) is fixed and does not vary dependent upon the size of the player's bet. Instead, in accordance with this embodiment, the size of a winning payout for at least one winning outcome increases as a function of the amount wagered. Preferably, the size of the average payout increases as the size of the bet increases. In one embodiment, the size of payouts for all winning combinations increase as the amount wagered increases.

In one embodiment, the outcomes, including their associated payouts, are stored in memories 244, 248, 252, 256. It is contemplated that the processor 224 monitors the amount wagered to determine which memory 244, 248, 252, 256 to access. A memory B1 244 stores data representing the payouts for outcomes when a first, or minimum, wager is placed, memory B2 248 stores data representing the payouts for outcomes when a second wager that is larger than the first wager, such as twice the minimum wager, is placed, while memory B3 252 stores data representing the payouts for outcomes when a third wager that is larger than the first or second wagers, such as three times the minimum wager, is placed.

It is contemplated that a gaming machine may have multi-denominational wagering capabilities where any multiple of a minimum wager is accepted by the gaming machine. As a consequence, a memory is shown, BN 256, that stores payout data representing the payouts for outcomes when a wager that is N times the minimum wager is placed.

To encourage a player to wager a maximum amount of money per round of play, it is contemplated a casino operator may configure that memory B3 252 to store a set of payouts that is proportionally greater than that of memory B2 248, while memory B2 248 stores a set of payouts that is proportionally greater than that of memory B1 244. It is contemplated that the payout for any outcome stored in memory 244, 248, 252, 256 may be varied to suit a gaming machine operator's preferences.

In a preferred embodiment of the invention, the size of the average winning payout for one or more payouts or winning combinations increases by more than the percentage increase in wager. In the embodiment illustrated, the size of the average winning payout provided for winning combinations when a player makes a maximum bet may be set to an exemplary 6.7% greater than the average winning payout for winning combinations that occurs when a player places a minimum wager. In this instance, a maximum bet of three times the minimum bet is configured to award the player 3.2 times the award provided for the same winning outcome on a minimum bet. In accordance with the prior art, the payout would increase only as a direct multiple of the size of the bet, i.e., 3 times the award on such a bet since the wager was 3 times the minimum wager.

In accordance with the other variation of this embodiment, the average payout or return of the machine varies as bet size varies. As is known, the average payout or return for a gaming machine is the amount which, over time, is paid back to players, as compared to held by the gaming machines, from all amounts wagered. The average payout may be quantified as the percentage of all wagered or bet amounts which are returned to players over time.

This embodiment may be implemented in a variety of manners. In particular, average machine return may be increased by modifying the payment for particular winning combinations, changing the odds of receiving a winning combination or the like.

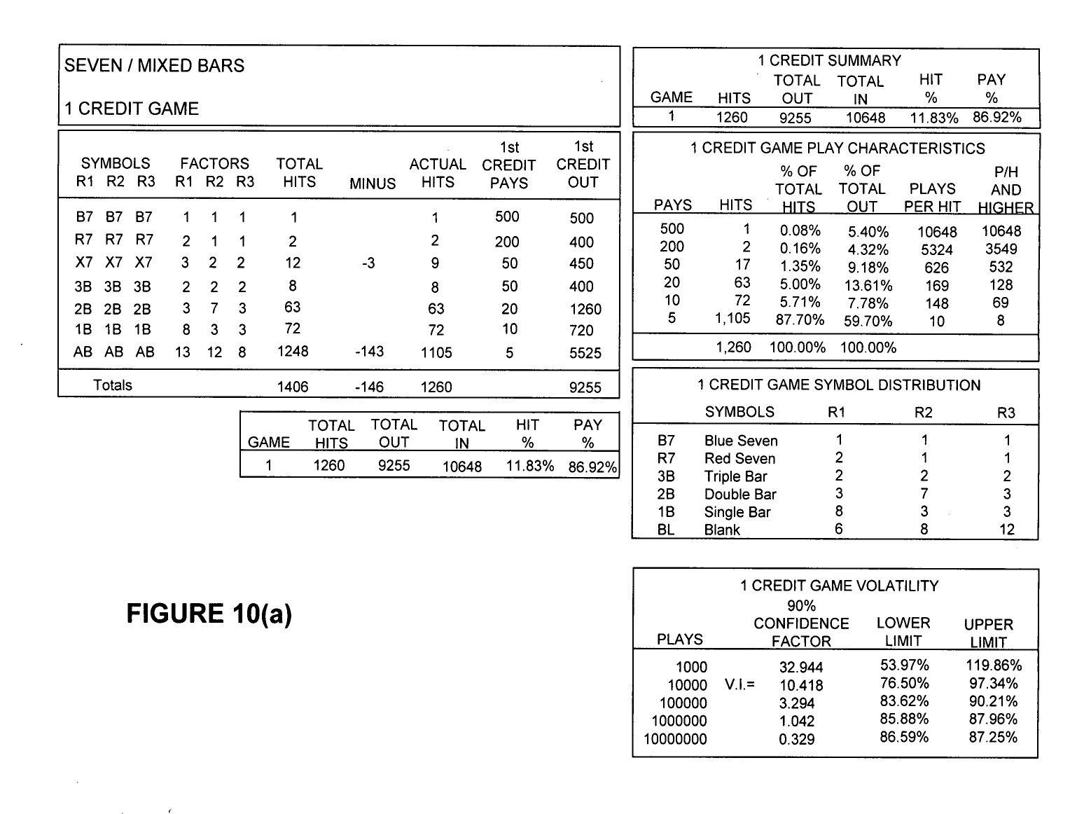

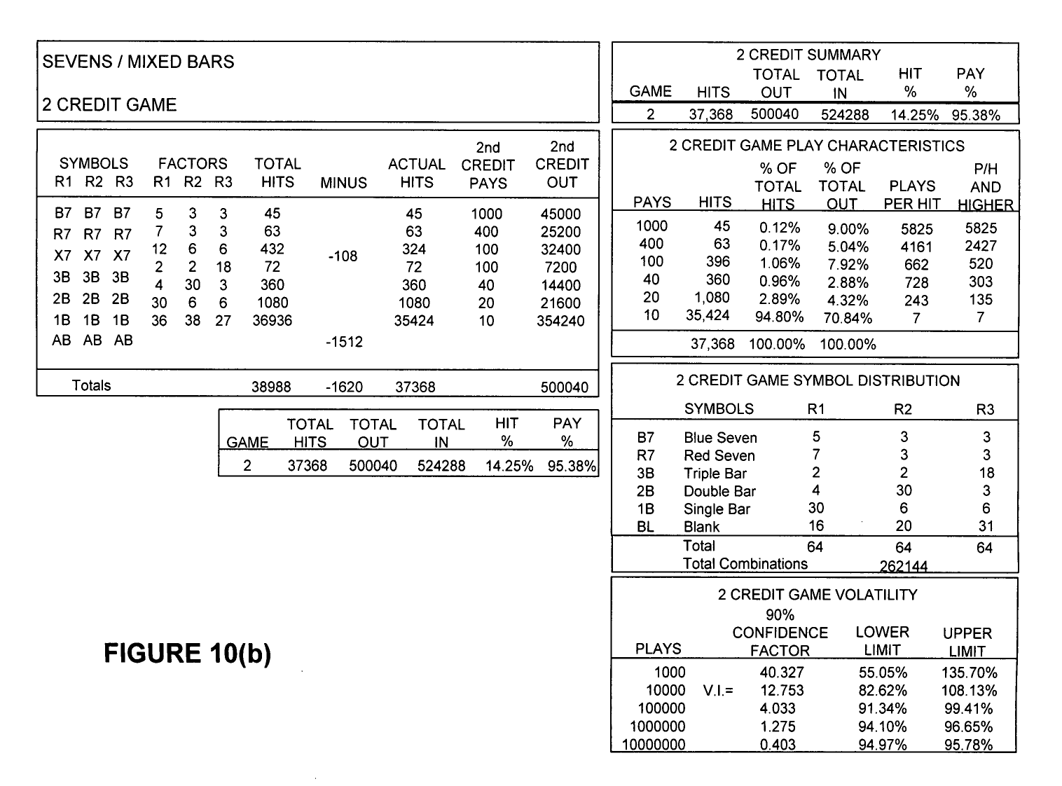

Preferably, in accordance with this variation, the average payout or return of the machine increases as bet size increases. One example of this embodiment of the invention is illustrated in FIG. 10(a). As illustrated in FIG. 10(a), a game is implemented as a “slot” type game having three reels, each reel capable of displaying a set of symbols. In this case, each reel is capable of displaying 22 symbols. The number of particular symbols appearing on each reel are indicated. For example, a single “Red 7” symbol appears on each of the three reels. Two “Blue 7” symbols appear on one reel, and one each on the other two reels. Other symbols appearing on the reels are “Three Bars,” “Two Bars,” , “One Bar,” and “blank.” Of course, other symbols may be used.

FIG. 10(a) further indicates the hit frequency or possible winning combinations for the reels as configured. In this case, the possible total combinations, or a single cycle, comprises 10648 (i.e., the number of symbols per reel multiplied together, 22*22*22). As illustrated, only one combination of “Red 7” may be received. FIG. 10(a) also illustrates the payout for the winning combination (i.e., 200 times the wager for three “Red 7” symbols), and the total payout per cycle for each winning combination.

As illustrated, there are 1260 winning combinations out of a total 10648 combinations for the reels and symbols so configured. In other words, the percentage of winning combinations to all combinations is 11.83%.

FIG. 10(a) illustrates an example payout when a player places a single unit bet, such as a single coin. In that event, the total winning payout for those winning combinations is 9255 units or coins, compared to 10648 units or coins which would be bet to receive all combinations (including non-winning combinations). The average payout is thus 9255/10648, or 86.92%. In other words, on average, 86.92% of all wagers or bets are returned to a player or players when the player or players are placing a bet of a first size, such as a single coin.

FIG. 10(b) illustrates an example of game play based upon a second wager. In this embodiment, the second wager is larger, and in particular is two times (i.e., two coins) that of the first size. As illustrated, the number of symbols which may be displayed on each reel are varied. In this embodiment, there are now 64 symbols on each of three reels. For example, the first reel now contains seven, instead of one, “Red 7.” Because of the variation in the symbols associated with each reel, the number of winning combinations out of all winning combinations varies. As illustrated, the total number of winning combinations to all combinations is 37368/262,144, or 14.25%. Based on the payouts for the winning combinations, 500040 coins or units would be paid out compared to 524288 coins wagered on all combinations, or a return of 95.38%.

In the variation illustrated, the payout for each particular winning combination has been doubled, matching the increase in size in the bet or wager. However, when considering the frequency of winning combination hits, the average payout has increased by nearly three percent (14.25 vs. 11.83%), and thus the average payout has increased by nearly 10% (95.38% to 86.92%).

As indicated, there are a variety of ways to change the average payout or return. For example, one way is to simply increase the average size of winning payouts. Other ways include changing the payouts for one or more winning combinations, changing certain non-winning combinations from losing to winning, and/or increasing the number of combinations which are winning.

FIGS. 10(a) and (b) illustrate the variation where the number of winning combinations is varied in combination with a change in payouts. This embodiment is particularly suited to a “video” slot configuration, where the particular symbols associated with each reel may be varied (as described above, in such a variation, the symbols are not physically associated with a reel, and instead data sets are used to represent the combinations of symbols).

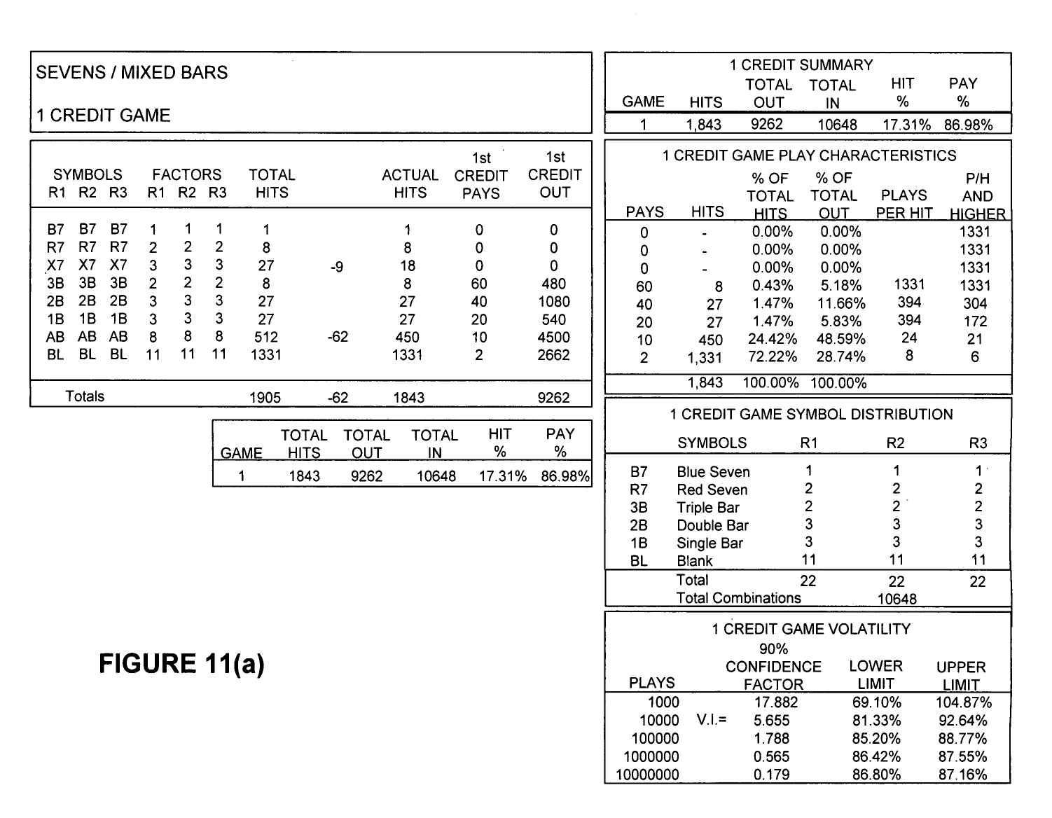

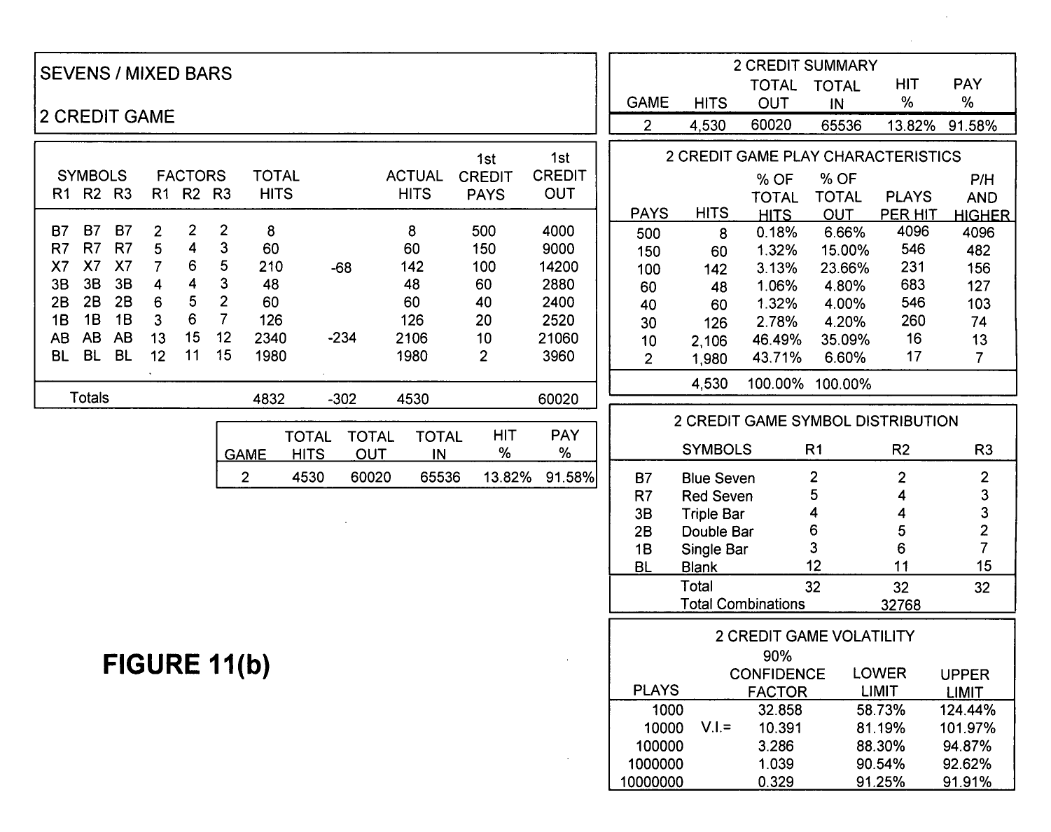

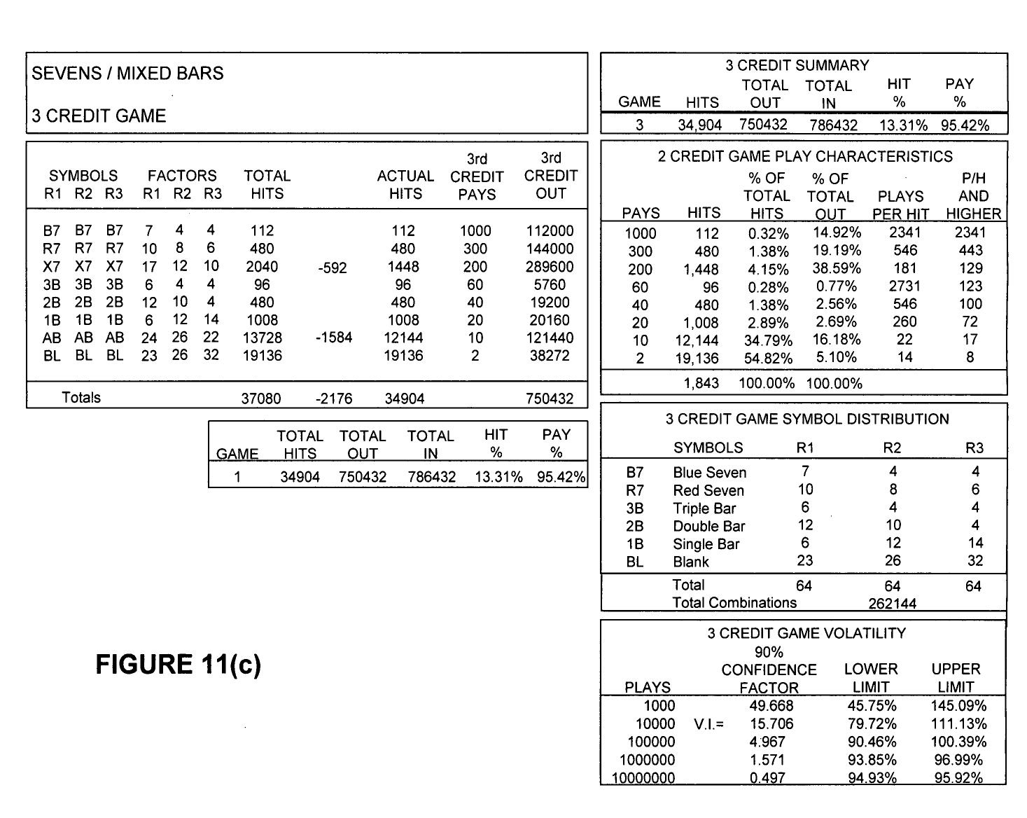

For example, FIGS. 11(a)-(c) illustrate yet another configuration for increasing average winning payout or return as the bet size increases. These figures illustrate the configuration of a game in which a player may place either a single unit or coin bet, two units or coins, or three units or coins. In this configuration, the average percentage of winning combinations actually decreases as bet size increases. Nonetheless, the average winning payout increases because of increases in payout for particular winning combinations.

It is contemplated that a gaming machine may be configured to implement either or both operational embodiments or methodologies as discussed. Thus, it is contemplated that the variation in win probability or the variation in payout as a function of the amount wagered by a player may be effected during a round of play. It is contemplated that a control circuitry in conjunction with the processor 224 may provide the control signals to enable or disable operation of either methodologies. The control circuitry is understood by one of ordinary skill in the art and as such is not described in detail herein. The methodologies employed may be programmed by way of an initialization routine or program provided by a Read Only Memory (ROM) 272 when the gaming machine is powered up. The ROM 272 may be configured to allow access to either the memories 228, 232, 236, 240 associated with varying the win probability or to memories 244, 248, 252, 256 associated with varying the payouts. It is contemplated that a technician may interchange one type of ROM 272 with the other to provide a change of operation. It is also contemplated that switching from one methodology to the other may be accomplished by way of control signals provided by a software program residing in ROM 272, RAM 268, or any other internal storage device, or externally from a computing device communicating through the interface 264.

It is contemplated that the interface 264 may serve to provide a communications channel to an external computing device capable of modifying or storing data contained in the memories 228, 232, 236, 240, 244, 248, 252, 256. For example, a casino operator sitting remotely in an office may wish to modify the outcome or payout data by reprogramming the data stored in memories 228, 232, 236, 240, 244, 248, 252, 256 over a remote terminal. In order to facilitate this, it is contemplated that memories 228, 232, 236, 240, 244, 248, 252, 256 comprise programmable memory devices.

The RNG 260 may be configured to generate any set or range of values. For example, the RNG 260 may be configured to generate random numbers from 1 to 100, 1 to 1000, or from 1 to 10,000. A random number generated from the RNG 260 should correspond to an outcome capable of being displayed by the gaming machine for viewing to a player.

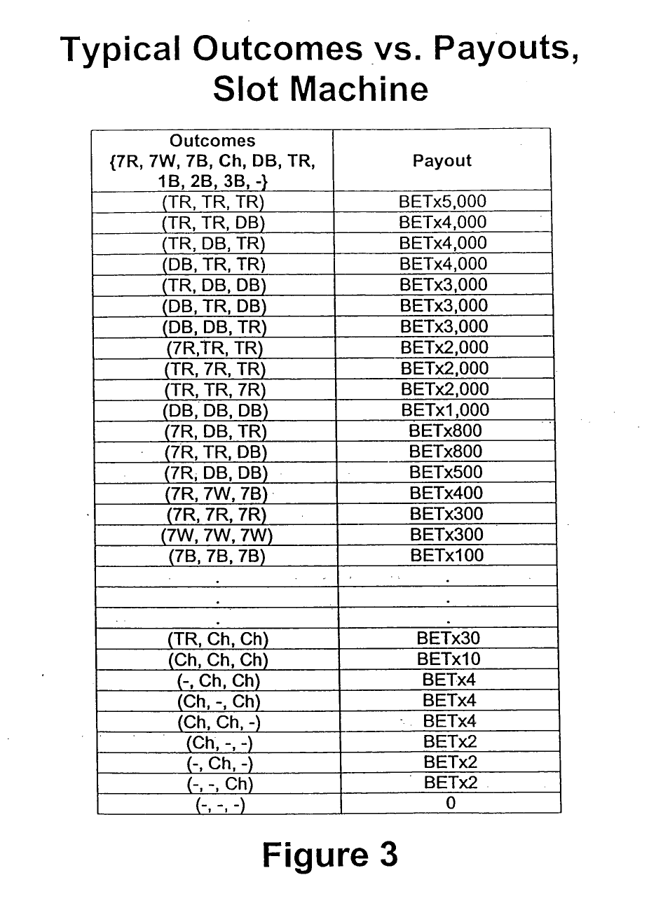

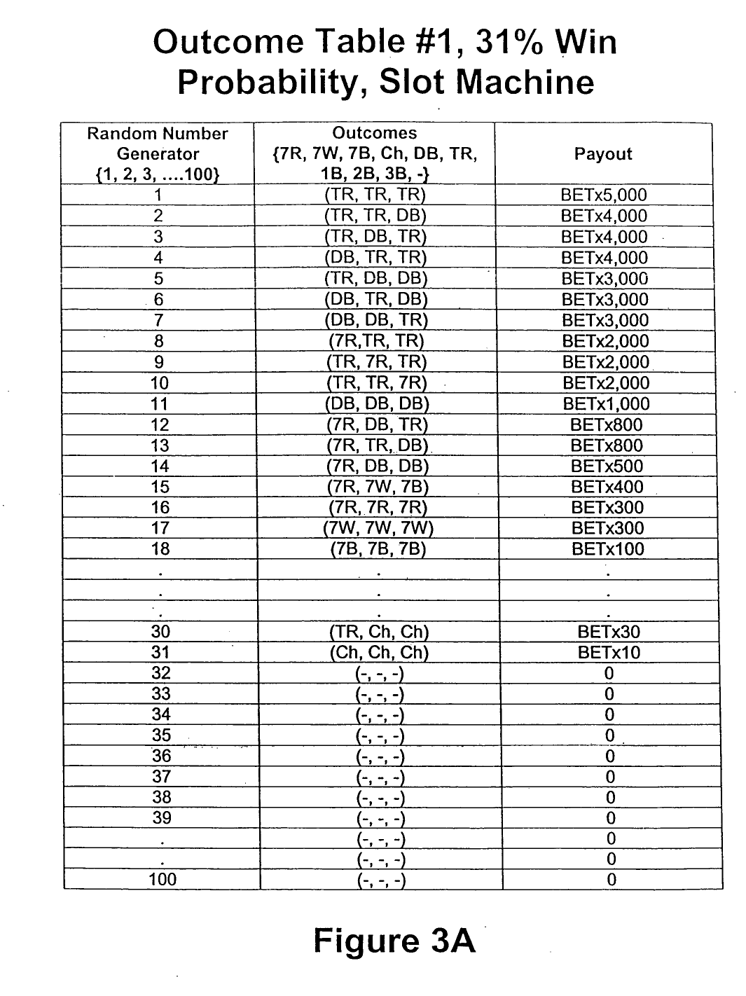

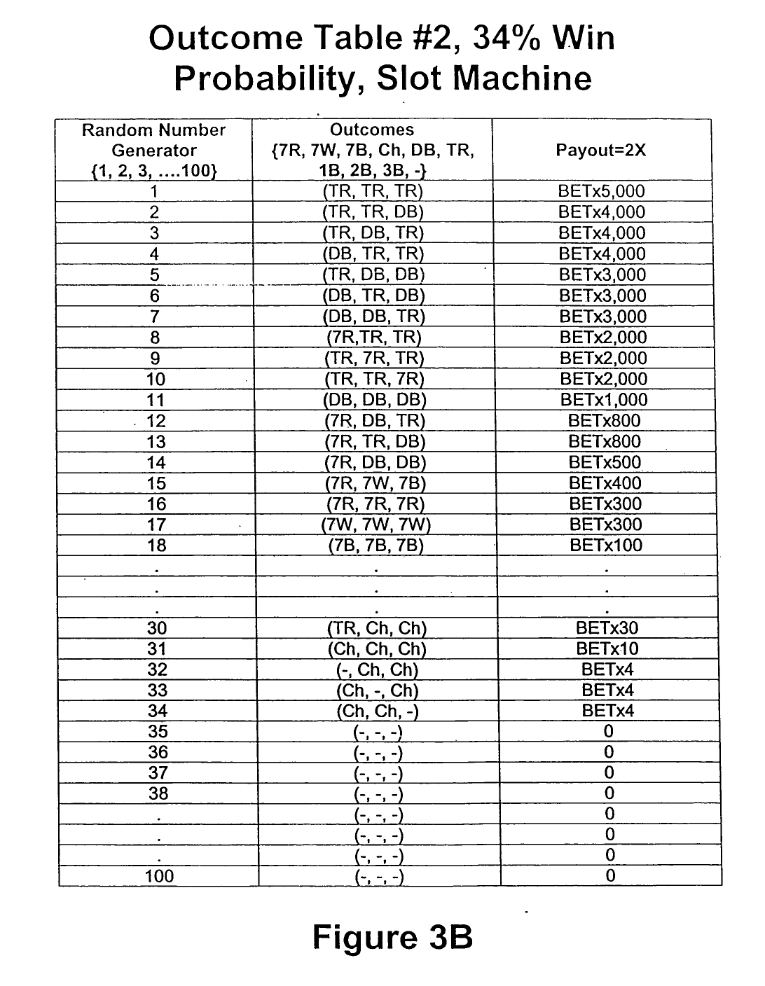

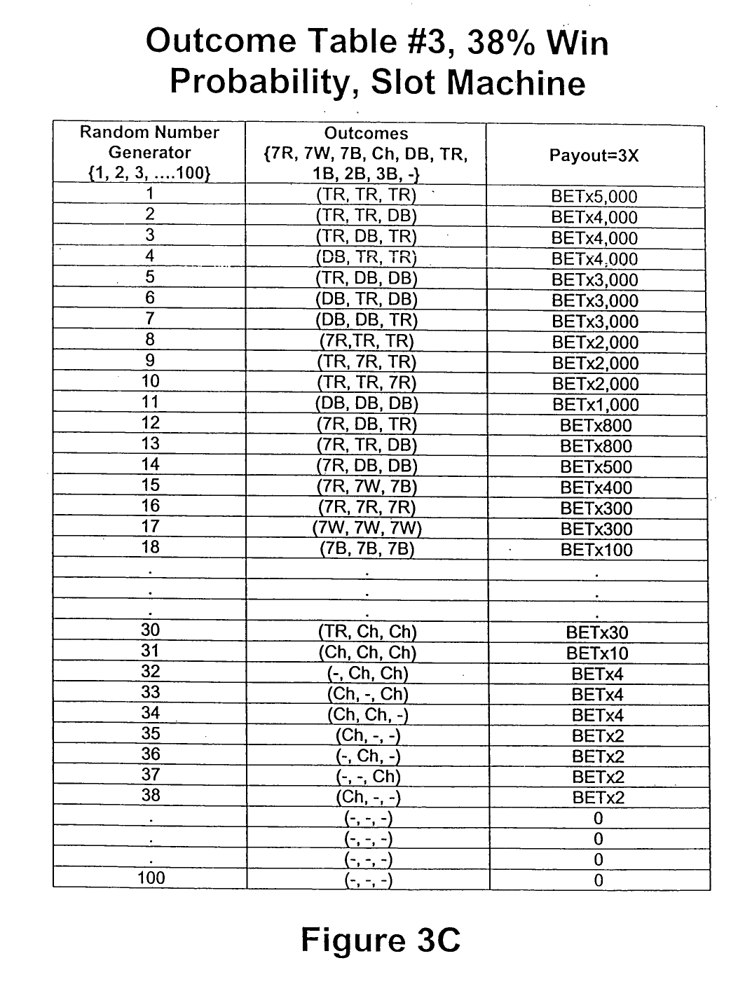

FIGS. 3, 3A, 3B, and 3C illustrate exemplary outcomes and payouts for the method illustrated in FIG. 2 where win probability varies as a function of the amount wagered by a player. FIG. 3 illustrates an exemplary set of outcomes provided by a typical slot machine when a minimum bet is wagered by a player. The table lists the payouts associated with all outcomes. In this embodiment, the win probability varies as a function of the amount wagered. It is contemplated the payout is linearly proportional to the amount wagered. For example, the payout on a bet that is twice the minimum wager is paid out at twice the minimum wager payout. For the sake of brevity, the payouts corresponding to outcomes between (7B, 7B, 7B) and (TR, Ch, Ch) are not shown as these details may be provided by one of ordinary skill in the art. The payouts associated with these winning outcomes may be any appropriate amount (i.e., amounts between BET×30 and BET×100) as may be determined by a gaming machine operator.

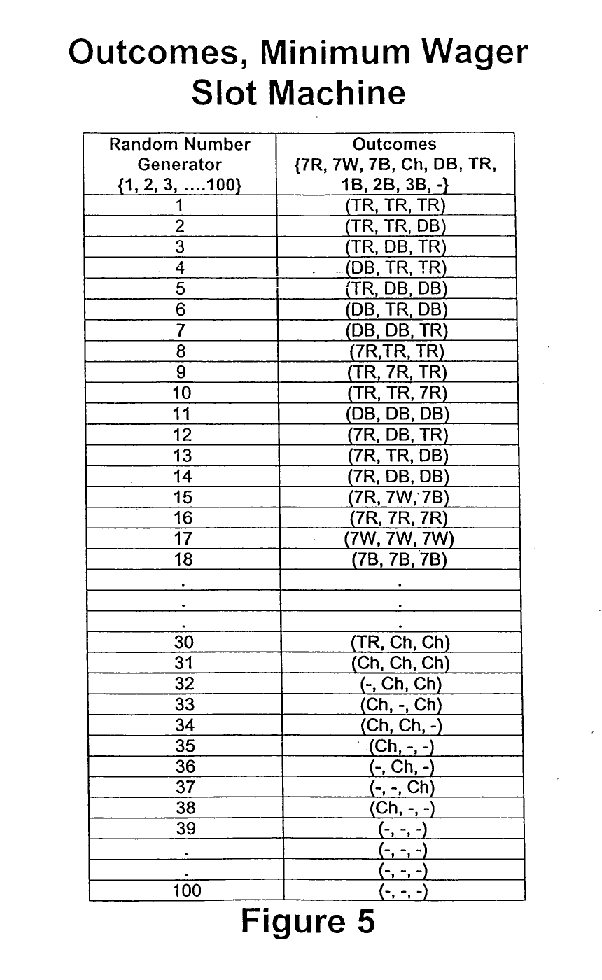

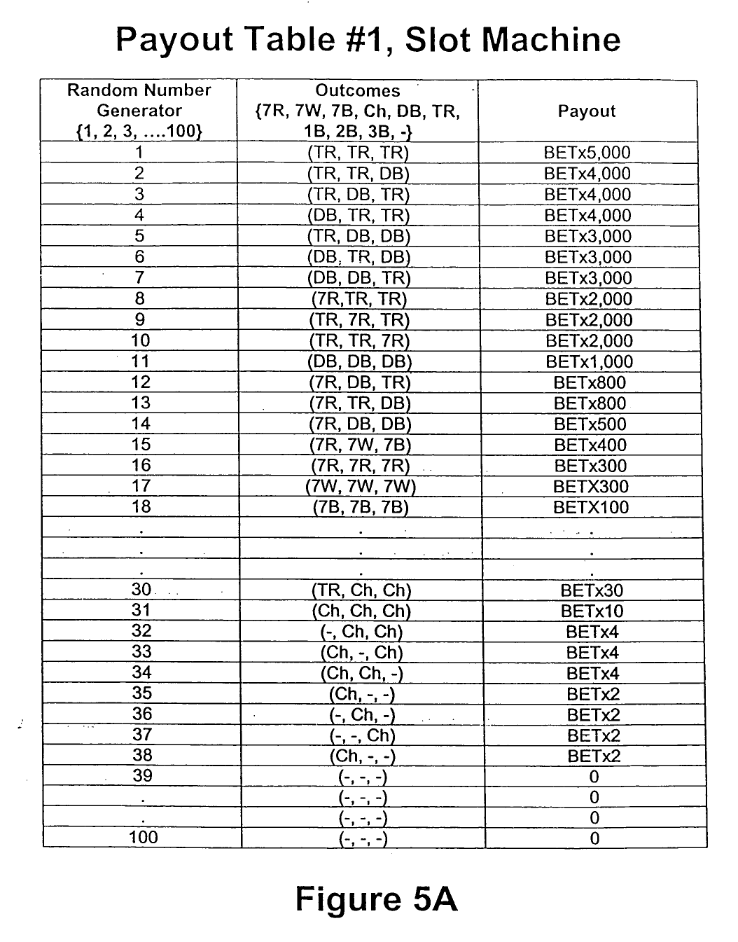

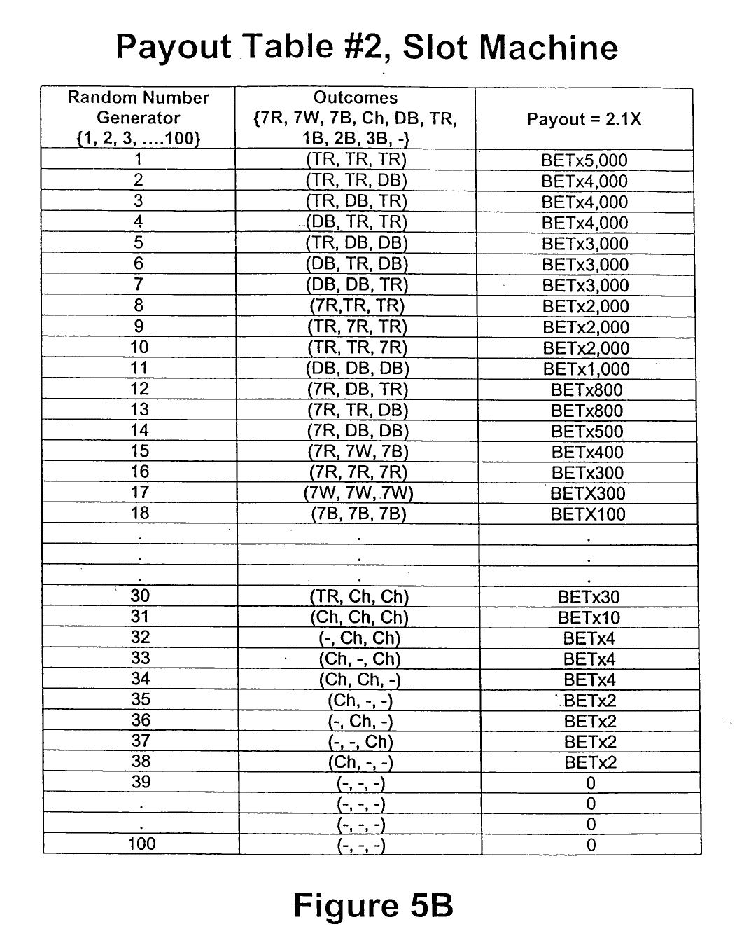

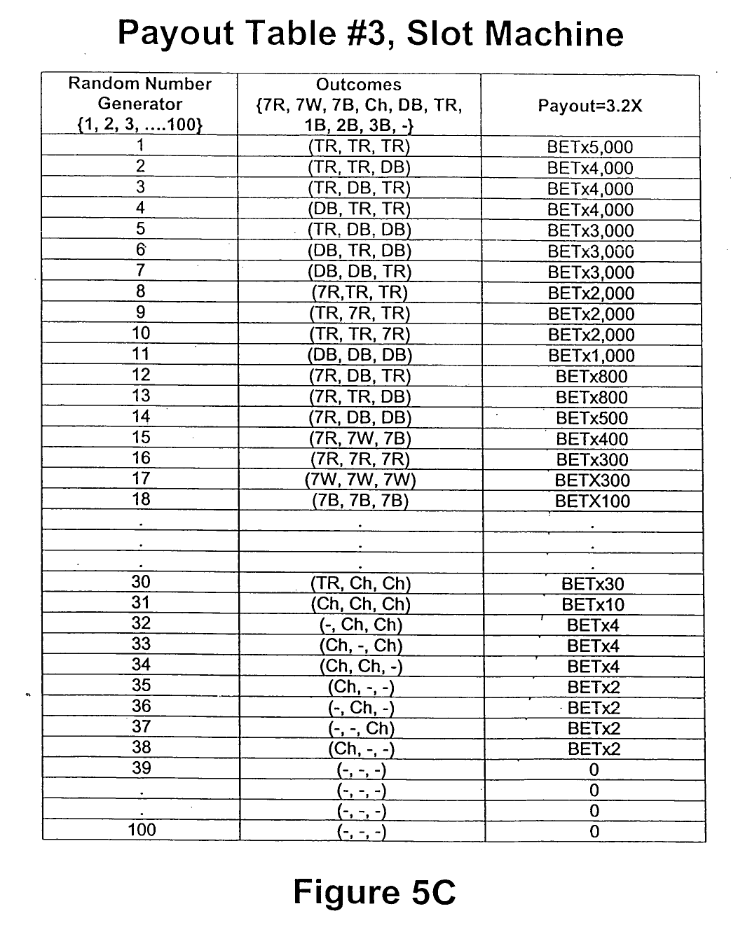

FIGS. 5, 5A, 5B, and 5C illustrate the outcomes and payouts for the method illustrated in FIG. 2 when payout varies as a function of the amount wagered by a player. FIG. 5 illustrates an exemplary set of outcomes provided by a typical slot machine. The table lists the outcomes associated with all random numbers generated by the RNG 260. In its preferred operational embodiment, the gaming machine is configured so that the size of the average payout increases as the amount wagered increases. For the sake of brevity, the outcomes corresponding to random numbers 18 through 29 are not shown, as these details may be provided by one of ordinary skill in the art. The winning outcomes may be any appropriate combination of symbols and may be determined by a gaming machine operator.

Prior to providing a detailed discussion of FIGS. 3A, 3B, 3C, 5A, 5B, and 5C, a description of the format of the tables in these figures is now provided. The first column corresponds to the random numbers generated by the RNG 260. In all figures, the random number generator generates integers starting from an exemplary value 1 and ending at an exemplary value 100. The second column provides the outcomes associated with a random number. In this embodiment, the outcomes are represented by a triplet of symbols representing a game of slots. The symbols are chosen from a set comprising the following exemplary elements: red7(7R), white7(7W), blue7(7B), cherry(Ch), double (DB), triple (TR), single bar (1B), double bar (2B), triple bar (3B), and blank(−). The third column provides the corresponding exemplary payouts associated with each outcome. In one embodiment, a losing outcome is represented by a payout of “0.”

In FIGS. 3A, 3B, and 3C, the payout rate is constant for a specific outcome; however, in the preferred operational embodiment, the win probability increases as the amount wagered increases. For example, the payout rate corresponding to (TR, TR, TR) does not vary amongst the tables (in all three cases, the payout rate for (TR, TR, TR) is BET×5,000).

In FIGS. 5A, 5B, and 5C, the number of winning outcomes, and thus the probability of receiving a winning combination, is not varied. For example, the number of winning outcomes remains the same at 38 out of 100 (or 38%) for all three tables. However, the payout amounts or rates for one or more of those winning combinations or outcomes do vary as a function of the amount wagered.

If the RNG 260 is configured to generate the integers from 1 to 100, a possible set of exemplary outcomes may be illustrated as shown in FIG. 3A for a player who bets a minimum wager. The gaming machine circuitry monitors the amount wagered and determines the appropriate memory 228 in which to access the set of outcomes. As illustrated in column 1 of FIG. 3A, there are a total of 31 possible winning outcomes out of 100 possible random numbers. In this instance, should the RNG 260 generate an integer from 1 to 31, the result is an outcome that has an associated payout. In this instance, an integer from 32 to 100 provides an outcome that corresponds to three blanks having an associated payout of 0. In sum, the overall win probability represented by this set of outcomes is 31%.

Should the player wager a larger amount, such as an amount equal to twice the minimum wager, an exemplary set of outcomes may be illustrated as shown in FIG. 3B. In this instance, the gaming machine circuitry determines the amount wagered to be larger, such as twice the minimum wager. As a result, the processor 224 queries the appropriate memory 232 in which to access the appropriate set of outcomes. As shown in column 1 of FIG. 3B, the RNG 260 may generate a total of 34 possible winning outcomes from a total of 100 possibilities. In this instance, should the RNG 260 generate an integer from 1 to 34, the result is an outcome that has an associated payout. If the random number is an integer from 35 to 100, the outcome is three blanks having an associated payout of 0. In sum, the overall win probability represented by these set of outcomes is 34%. Hence, a larger bet, such as an incremental bet to twice the minimum wager, has increased the win probability by 3%.

Should the player wager an even larger amount, such as an amount that is three times the minimum wager, an exemplary set of outcomes may be illustrated as shown in FIG. 3C. In this instance, the processor 224 determines the amount wagered to be a third, larger amount, such as three times the minimum wager. As a result, the processor 224 accesses the appropriate location in memory 236 in which to access the appropriate set of outcomes. As shown in column 1 of FIG. 3C, the RNG 260 may generate a total of 37 possible winning outcomes from a total of 100 possibilities. Should the RNG 260 generate an integer from 1 to 38, the result is an outcome that has an associated payout. Any integer from 39 to 100 provides an outcome corresponding to three blanks having an associated payout of 0. In sum, the overall win probability represented by these set of outcomes is 38%. Hence, an incremental larger bet, such as three times the minimum wager, has increased the win probability by 7%.

The outcomes represented in FIGS. 3A, 3B, and 3C correspond to the case where N=3 or that the gaming machine will accept three different bet amounts or ranges, such as bets up to three times the minimum wager. It is contemplated that the outcomes may be varied to suit the objectives of the gaming machine operator and that the variation in winning outcomes between FIGS. 3A 3B, and 3C are exemplary. It is contemplated that the types of winning outcomes may be changed in memory as desired by the gaming machine operator. For example, a (Ch-, -) may be replaced with (7B, 7B, 7B) providing a change in payout of 150×. However, the associated payout rate corresponding to these outcomes may not be varied as was illustrated in FIG. 3. Although the number of winning outcomes (or % win probability) are allowed to vary between the sets of outcomes shown in FIGS. 3A, 3B, and 3C, the payout rate remains constant for an outcome.

As opposed to (or in addition to) varying the win probabilities for a particular amount wagered, it is contemplated that the gaming machine operator may wish to vary the payout(s) associated with an outcome(s) as a function of the amount wagered. FIGS. 5A, 5B, and 5C illustrate exemplary payouts as the amount wagered is changed. If the RNG 260 is configured to generate the random numbers from 1 to 100, a possible set of exemplary payouts can be illustrated as shown in FIG. 5A for a player who bets a minimum, or first, wager.

As indicated previously, the gaming machine circuitry, such as the processor 224, random access memory 268, and coin/token sensor 208, monitor the amount wagered and determine the appropriate memory 244 in which to access the payout data.

As illustrated in FIGS. 5A, 5B, and 5C, there are a total of 38 possible winning outcomes out of 100 possible random numbers. In this exemplary configuration, when the RNG 260 generates an integer from 1 to 38, the result is an outcome that has an associated payout. Any integer value generated from 39 to 100 provides an outcome corresponding to three blanks having an associated payout of 0. As illustrated, the payouts for winning combinations increase as a player increases his wager from a minimum wager as exemplified in FIG. 5A to a maximum wager as exemplified in FIG. 5C. As shown in FIG. 5B, the player wagers an amount that is larger, such as twice the minimum bet, resulting in payouts that are 210% of what is paid out as shown in FIG. 5A. When the wager is at a maximum, or third amount, the payout is 320% of what is paid out as shown in FIG. 5C. It is contemplated that the outcomes associated with FIGS. 5A, 5B, and 5C correspond to the case where N=3. In this case, the gaming machine will accept three bets or bet ranges, such as bets up to three times the minimum wager. Further, it is contemplated that the payouts may be varied to suit the objectives of the gaming machine operator and that the payouts shown in FIGS. 5A, 5B, and 5C are exemplary.

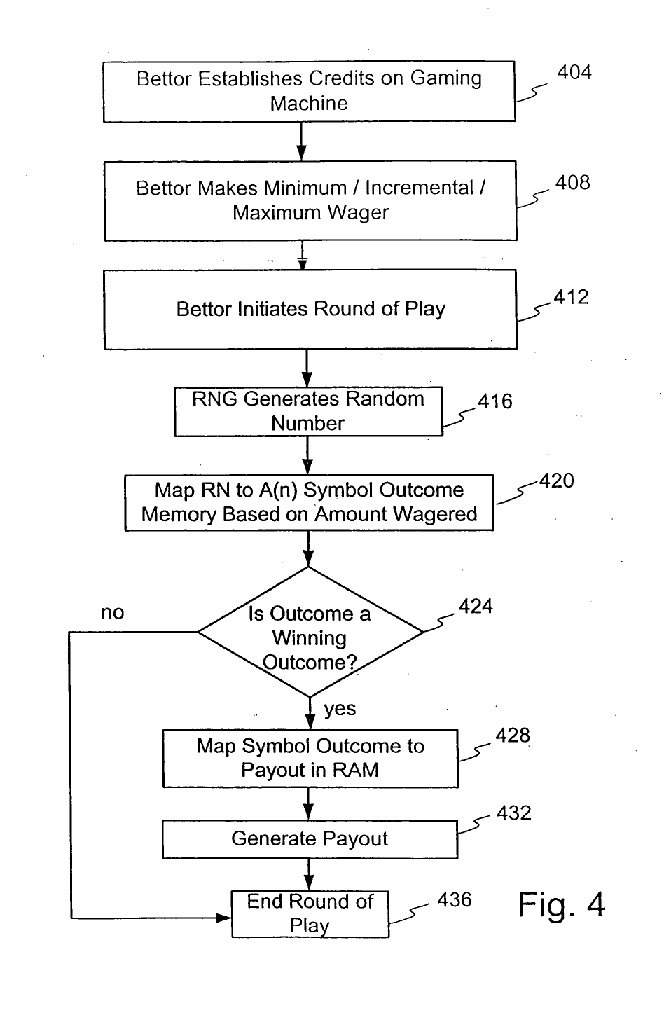

FIG. 4 provides an operational flow diagram of one method of the invention where the probability of receiving a winning outcome increases as an amount wagered increases. In step 404, the player or bettor establishes credits on a gaming machine by inserting paper currency into a bill validator, depositing coins or tokens into a coin/token acceptor or inserting a credit, debit type, or like type card which facilitates a transfer of funds from one's account to the gaming machine. The bettor may use any combination of the above deposit methods to generate credits in the gaming machine. Deposits are added to a cumulative total number of credits accounted for and displayed by the gaming machine. In step 408, the bettor makes a wager on the gaming machine. The wager may be accomplished by depressing a single bet button in which the bettor wagers a minimum bet. By depressing the single bet button multiple times, the bettor may wager any amount of credits up to a maximum number as designated on the gaming machine. It is contemplated that the bettor may depress a maximum bet button to facilitate a maximum wager. In a step 412, the player makes a decision to initiate the round of play by depressing a spin reels button (or pulling a handle) in the exemplary case of a gaming machine providing a game of slots. Should the player make a decision to initiate the round of play by pulling the handle or pressing the spin button at the time when a minimum bet is wagered, the processor causes the RNG to generate a random number, as shown in a step 416. The random number is used to determine the outcome of the game. As indicated, this comprises generating or obtaining a symbol outcome from memory (memory A1 in the case of the system illustrated in FIG. 2) associated with the minimum amount wagered, as indicated in a step 420. The symbol outcome associated with the random number is displayed on the gaming machine for viewing by a player. The symbol outcome in a game of slots may be three cherries (Ch, Ch, Ch), two bars and one cherry (1B, 1B, Ch), and the like.

In a step 424, a determination is made whether the outcome is a winning or losing outcome. If the outcome is a losing outcome, the round of play ends at a step 436. If the outcome is a winning outcome, the process proceeds to a step 428, in which a payout associated with the outcome is determined or obtained, such as by mapping the outcome to a payout stored in any memory, such as in random access memory or read only memory or the like. The payout data stored in random access memory may be loaded as part of the gaming machine initialization routine. In a step 432, an associated payout is generated. The round of play terminates in the next step, 436.

The total amount wagered may vary, such as being any integer multiple of a minimum bet (i.e., two or three coins). When the player or bettor decides to initiate the round of play, as indicated in a step 412, the process proceeds by the RNG generating a random number in a step 416. The random number is used to generate a symbol outcome from memory (A1-AN, FIG. 2) in conjunction with the amount wagered as indicated in a step 420. The symbol outcome associated with the random number is displayed on the gaming machine. In a step 424, a determination is made whether the symbol outcome is a winning or losing outcome. If the outcome is a losing outcome, the round of play ends at a step 436. If the outcome is a winning outcome, the process proceeds to a step 428, in which the payout is determined by mapping the outcome to a payout stored in any memory, such as in random access memory. An associated payout is generated in a step 432, and the round of play terminates in a step 436.

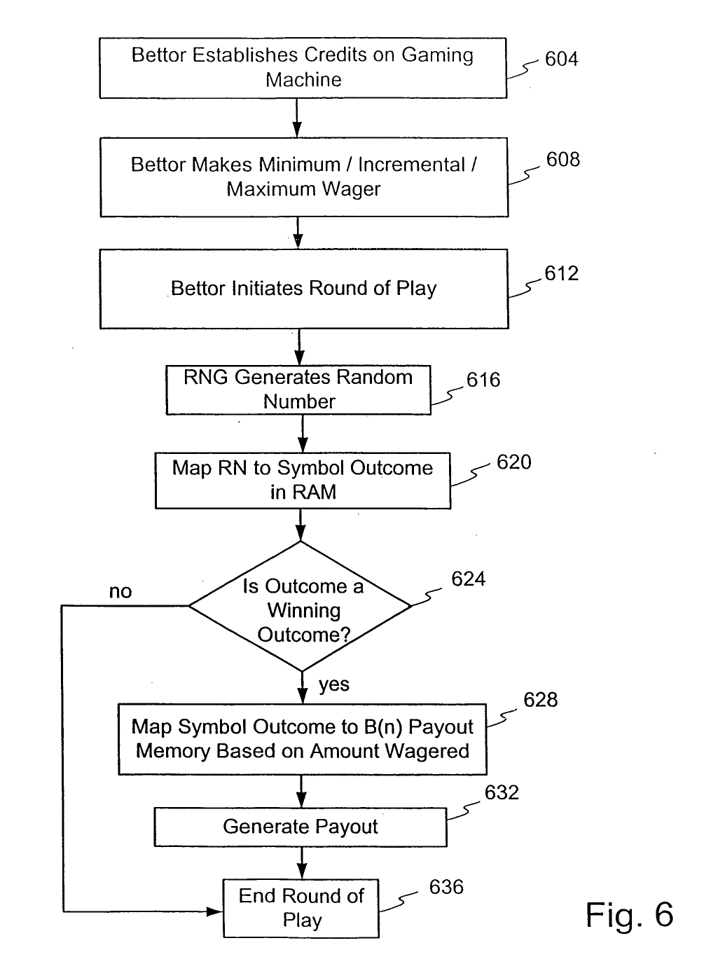

FIG. 6 provides an operational flow diagram of a method where the payout for one or more winning combinations increases as an amount wagered increases. In a step 604, the player or bettor establishes credits on a gaming machine by inserting paper currency into a bill validator, depositing coins or tokens into a coin/token acceptor or inserting a credit, debit type, or like type card which facilitates a transfer of funds from one's account to the gaming machine. The bettor may use any combination of the above deposit methods to generate credits in the gaming machine. Deposits are added to a cumulative total number of credits accounted for and displayed by the gaming machine. In a step 608, the bettor makes a wager on the gaming machine. The wager may be accomplished by depressing a single bet button in which the bettor wagers a minimum bet. By depressing the single bet button multiple times, the bettor may wager any amount of credits up to a maximum number as designated on the gaming machine. It is contemplated that the bettor may depress a maximum bet button to facilitate a maximum wager. In a step 612, the player makes a decision to initiate the round of play by depressing a spin reels button (or pulling a handle) in the exemplary case of a gaming machine providing a game of slots. Should the player make a decision to initiate the round of play by pulling the handle or pressing the spin button at the time when a minimum bet is wagered, the processor causes the RNG to generate a random number, as shown in a step 616.

In a step 620, the random number is used to generate or obtain an outcome from memory such as a random access memory. The outcome data may be may be loaded into the random access memory as part of the gaming machine initialization routine. The symbol outcome associated with the random number is displayed on the gaming machine for viewing by a player.

In a step 624, a determination is made whether the symbol outcome is a winning or losing outcome. If the symbol outcome is a losing outcome, the game or round of play ends at a step 636. If the outcome is a winning outcome, the process proceeds to a step 628, in which the outcome is mapped to a payout from memory B1 (as shown in FIG. 2) associated with the minimum amount wagered, as indicated in a step 628. In a step 632, an associated payout is generated. The round of play terminates in the next step, 636.

The total amount wagered may vary, such as being any integer multiple of a minimum bet (i.e., two or three coins). When the player or bettor decides to initiate the round of play, as indicated in a step 612, the process proceeds by the RNG generating a random number in a step 616. The random number is used to generate or determine a symbol outcome from a memory such as an exemplary random access memory (as shown in FIG. 2). In a step 624, a determination is made whether the outcome is a winning or losing outcome. If the outcome is a losing outcome, the round of play ends at a step 636. If the outcome is a winning outcome, the process proceeds to a step 628, where the payout is determined, such as by mapping the outcome to a payout stored in the appropriate payout memory (B1-BN, FIG. 2), based on the amount wagered by the player. An associated payout is generated in a step 632, and the round of play terminates in a step 636.

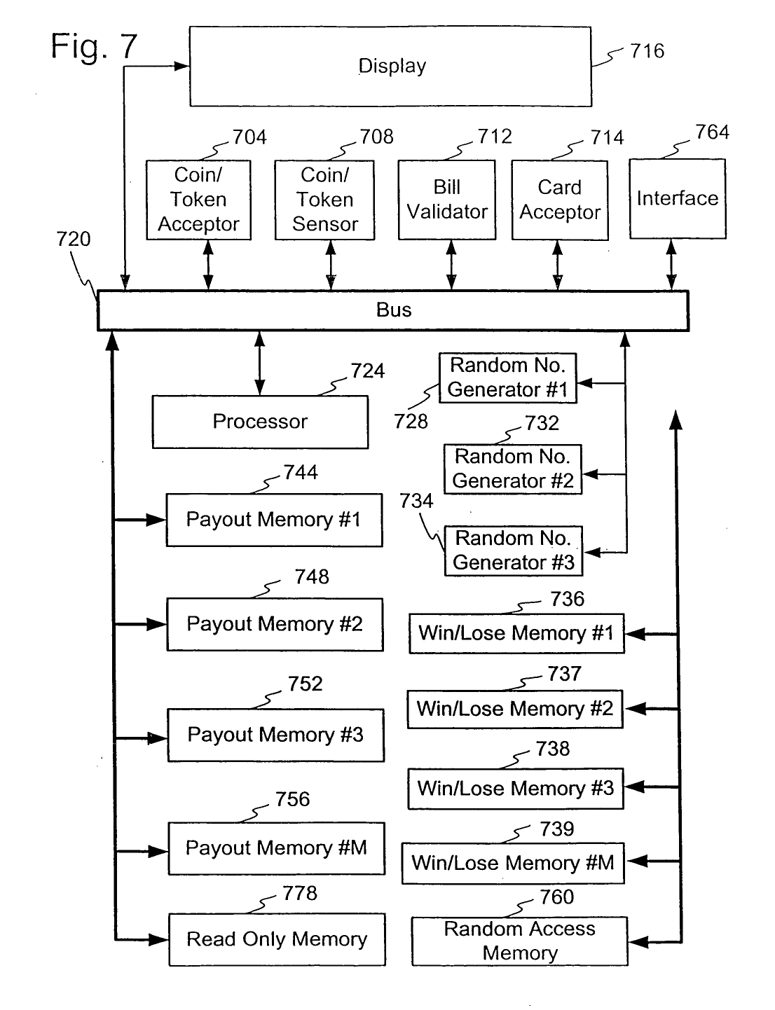

FIG. 7 illustrates yet another embodiment of a system in accordance with the present invention, which system may be used at a gaming machine to implement a variation in win probabilities or payout as a function of amount wagered in a game or round of play. This system includes three random number generators 728, 732, 734. A first random number generator 728 is used to determine whether the outcome is a winning or losing outcome, the second random number generator 732 is used to generate symbols representing a winning outcome, while the third random number generator 734 is used to generate symbols representing a losing outcome.

As shown a coin/token acceptor 704 accepts coins or tokens inserted by a player. The coin/token acceptor 704 may accept coins of one or more denominations. In other instances, tokens may be obtained in lieu of cash as provided in a casino. It is contemplated that any number of coins or tokens may be accepted prior to a round of play. A coin/token sensor 708 senses the quantity of coins accepted prior to a round of play and provides this information to a processor 724 for processing. The processor 724 comprises a central processing unit that facilitates computations and logical functions within the gaming machine. The coin/token sensor 708 may act to verify or authenticate the coin/token deposited into the coin/token acceptor 704. The coin/token sensor 708 may also provide a signal indicating that a coin/token was successfully deposited into the coin/token acceptor 704. Information provided by the coin/token sensor 708 communicates to the processor 724 by way of a communication bus 720. The bus 720 acts as a high speed medium in which data may communicate between different functional devices within the gaming machine.

A bill validator 712 provides acceptance of paper currency of different denominations. Upon the acceptance of paper currency, the bill validator 712 either dispenses tokens/coins or establishes a number credits on the gaming machine equivalent to the currency accepted. As a convenience to the player or bettor, a card acceptor 714 may accept a credit or debit type card, facilitating the transfer of funds from one's account into equivalent credits on the gaming machine.

The coin/token sensor 708, bill validator 712, and card acceptor 714 interact with the processor 724 to provide a cumulative total of the amount of credits accumulated for use by the player. The cumulative total may be stored in a random access memory 760. The random access memory 760 may store data related to the accounting history of a gaming machine. When coins or tokens are deposited into the gaming machine, the processor 724 increments the number of credits in the random access memory 760 accordingly. When a round of play occurs, the processor 724 decrements the number of credits in the random access memory 760 by the amount wagered. The number of credits may be displayed in an appropriate location on the body of the gaming machine.

In this embodiment, the coin/token sensor 708 provides input to the processor 724 when a coin or token is inserted into the gaming machine. Similarly, a player pressing a single bet button or maximum play button will provide inputs to the processor 724. These inputs determine the total amount wagered prior to the player initiating a round of play. When a round of play is initiated, a random number is generated by the first random number generator 728 and is mapped to data stored in a win/lose memory 736-739. The win/lose memories 736-739 comprise data used to determine the percent win probability associated with an amount wagered. It is contemplated that the data in win/lose memory comprise win or lose outcomes associated with all random numbers generated by the first random number generator 728. Win/lose memory #1 736 comprises data associated with win/lose outcomes corresponding to a first, or minimum, wager, win/lose memory #2 737 comprises data associated with win/lose outcomes corresponding to a second, or intermediate, wager, while win/lose memory #3 738 comprises data associated with win/lose outcomes corresponding to a third, or maximum, wager. The win/lose memory #M 739 stores win/lose outcome data in the case that a gaming machine accepts M times the minimum wager. It is contemplated that this data may be downloaded into the win/lose memory 736-739 remotely via an interface 764 by a remote computing device. It is also contemplated that the data may be stored in the win/lose memory 736-739 during an initialization process generated by a read only memory 778 when the gaming machine is turned on. In other cases, it is contemplated that the win/lose outcomes may be stored in a software program within the win/lose memory 736 that is initiated when a round of play commences.

The second random number generator 732 generates a random number that is mapped to data associated with a winning outcome stored in the random access memory 760 or the like. The third random number generator 734 generates a random number that is mapped to data associated with a losing outcome stored in the random access memory 760 or the like. The random access memory 760 contains all winning and losing outcomes associated with any random number generated by the second random number generator 732. The appropriate address within the random access memory 760 is accessed depending on whether the first random number generates a win or a lose outcome.

Payout memories 744, 748, 752, 756 comprise memory containing payout data. The appropriate memory 744, 748, 752, 756 is accessed during a round of play corresponding to the amount wagered by the player. In the instance when only the payouts are made to vary according to the amounts wagered by the player, it is contemplated that a subset of these memories 744, 748, 752, 756 is accessed and read. For example, only the first payout memory 744 may be utilized when a minimum bet is wagered. The first payout memory 744 stores data corresponding to the payouts associated with a minimum wager, the second payout memory 748 stores data corresponding to the payouts associated with a wager that is twice the minimum wager, while the third payout memory 752 stores payout data associated with a wager that is three times the minimum wager. It is contemplated that a gaming machine may have multi-denominational wagering capabilities where any multiple of a minimum wager is accepted by the gaming machine. As a consequence, an Mth payout memory 756 is contemplated that stores payout data corresponding to a wager that is M times the minimum wager. To encourage a player to wager a larger amount of money per round of play, it is contemplated a gaming machine operator may configure the third payout memory 752 to store a set of payouts that is greater than that of the second payout memory 748, while the second payout memory 748 is configured to store a set of payouts that is greater than that of the first payout memory 744. It is contemplated that the payouts for any outcomes stored in memory 744, 748, 752, 756 may be varied to suit a gaming machine operator's preferences.

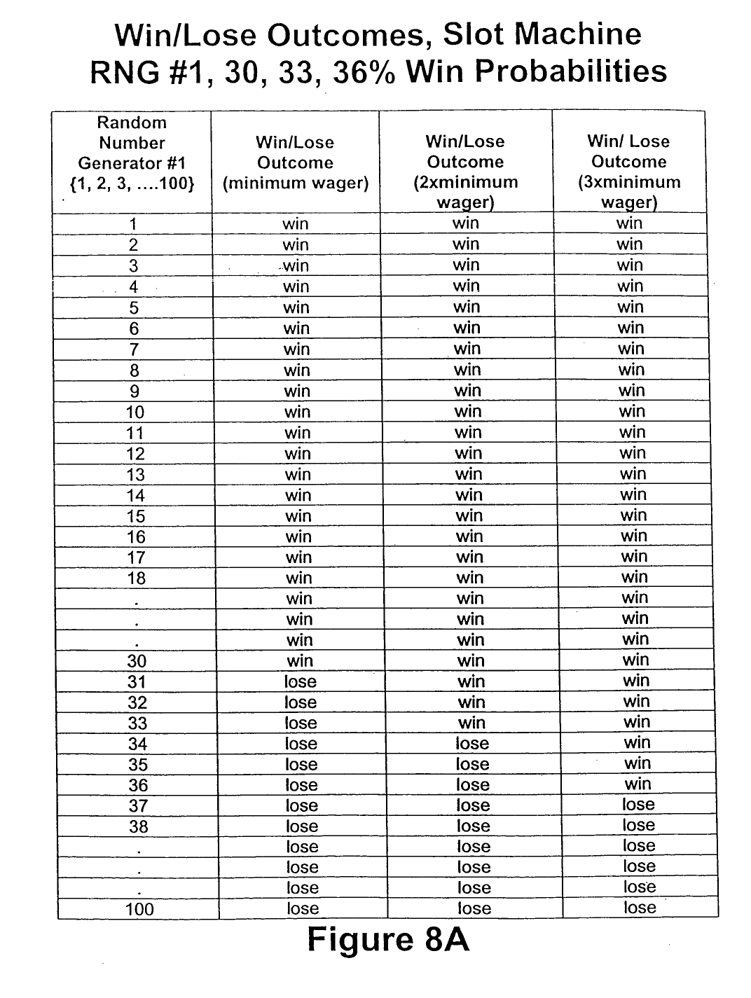

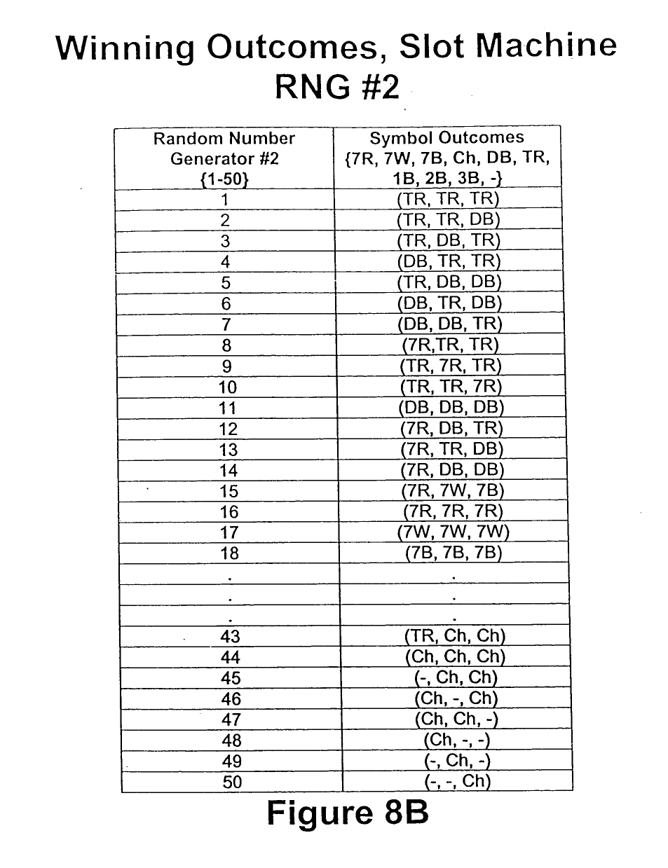

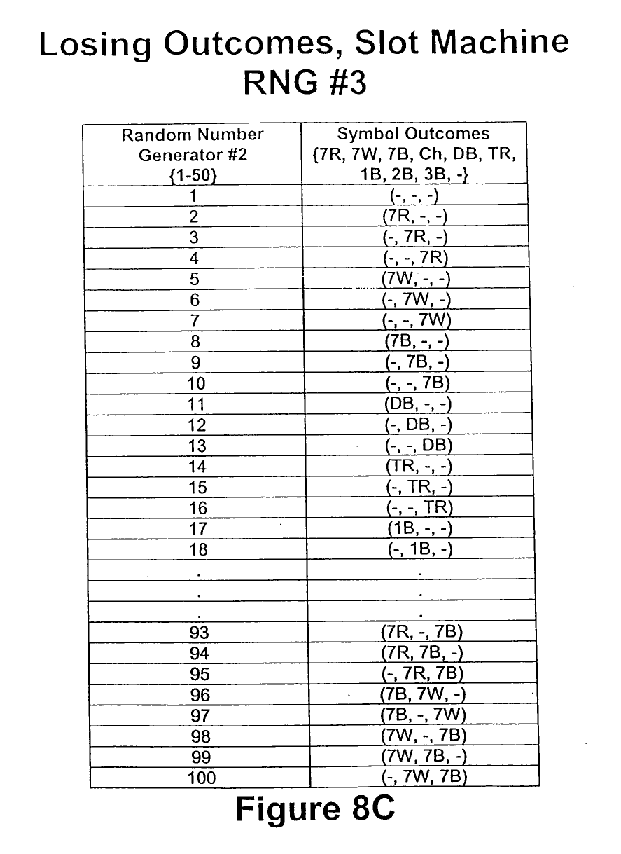

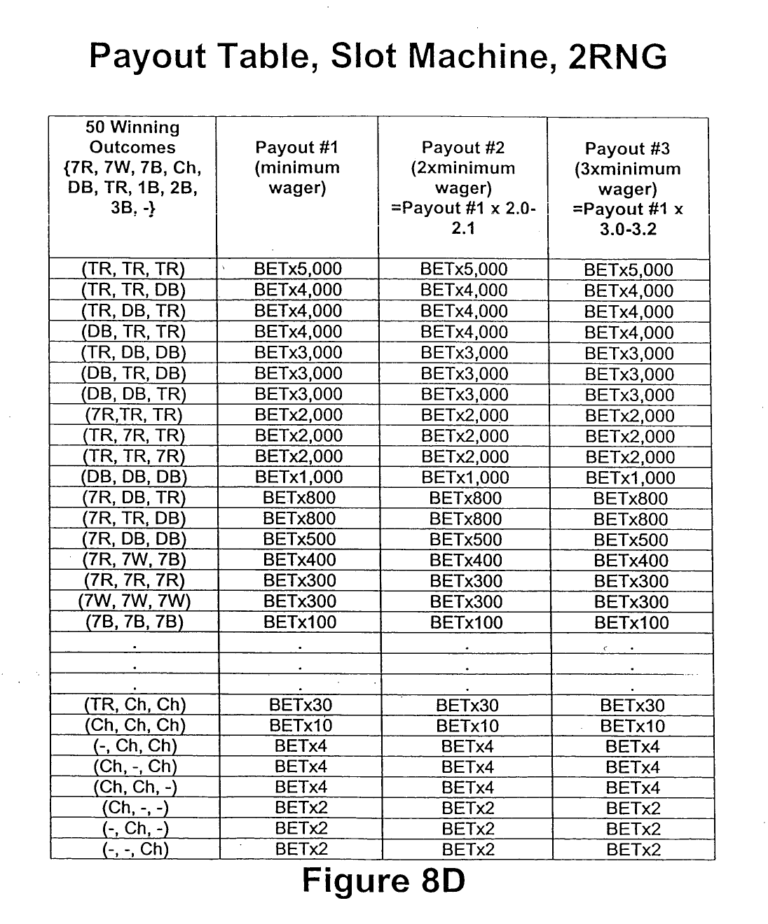

FIGS. 8A, 8B, and 8C illustrate exemplary win/lose outcomes, symbol outcomes, and payouts associated with the embodiment shown in FIG. 7 when win probability or a payout is varied as a function of the amount wagered by a player. FIG. 8A lists the win/lose outcomes associated with all random numbers produced by the first random number generator. The first random number generator is configured to generate 100 integers starting from the integer value 1 and ending at 100. As shown in this exemplary table, the number of winning outcomes is configured to increase as the wager is maximized. When the wager is three times the minimum wager, there are 36 winning outcomes out of 100 random numbers, yielding a 36% win probability. When the wager is at minimum, the win probability is 30%.

FIG. 8B provides symbol outcomes as generated by the second random number generator for all winning outcomes as determined by the first random number generator. As illustrated in FIG. 8B, there are an exemplary 50 symbolic winning outcomes representing a typical game of slots. Symbolic outcomes not represented in the symbolic winning outcomes set may be categorized as losing outcomes corresponding to a payout of 0. For the sake of brevity, the win/lose outcomes corresponding to random numbers between 19 and 29 are not shown in FIGS. 8A and 8B, as these details may be provided by one of ordinary skill in the art. An example of a symbol outcome is three cherries (Ch, Ch, Ch) which results when the second random number is the integer 44.

FIG. 8C provides symbol outcomes as generated by the third random number generator for all losing outcomes as determined by the first random number generator. As illustrated in FIG. 8C, there are 100 exemplary losing symbol outcomes. The number of outcomes and corresponding symbols are exemplary and may be configured as desired by a gaming machine operator. For the sake of brevity, the payouts for losing outcomes are not illustrated, as all such outcomes correspond to zero payouts. An example of a losing symbol outcome may be a triplet corresponding to three blanks (-, -). In this exemplary mapping of random numbers to symbol outcomes, this outcome results when the third random number corresponds to the value 1.

FIG. 8D provides exemplary payouts for a winning outcome as a function of the amount wagered by the player. For the sake of brevity, the payouts between winning outcomes (7B, 7B, 7B) and (TR, Ch, Ch) are not shown in FIG. 8D, as these details may be provided by one of ordinary skill in the art. As illustrated, the payout rate may be configured to be proportional to the amount wagered or may be configured to increase non-linearly as the minimum bet is increased. If the payout is set proportionally, the payout for a bet that is twice the minimum bet would result in a payout that is 200% of a minimum wager payout. In instances when the gaming machine operator wishes to provide an incentive to wager a maximum amount per round, the payout rate may be set so that the rate is at 210% when the player wagers an amount that is twice the minimum bet (one would expect a 200% payout). When the wager is three times the minimum bet, the payout may be set at 320% of the minimum bet. Of course, the payouts associated with these winning outcomes may be set to any amount (i.e., any amount between BET×30 and BET×300) as desired by a gaming machine operator.

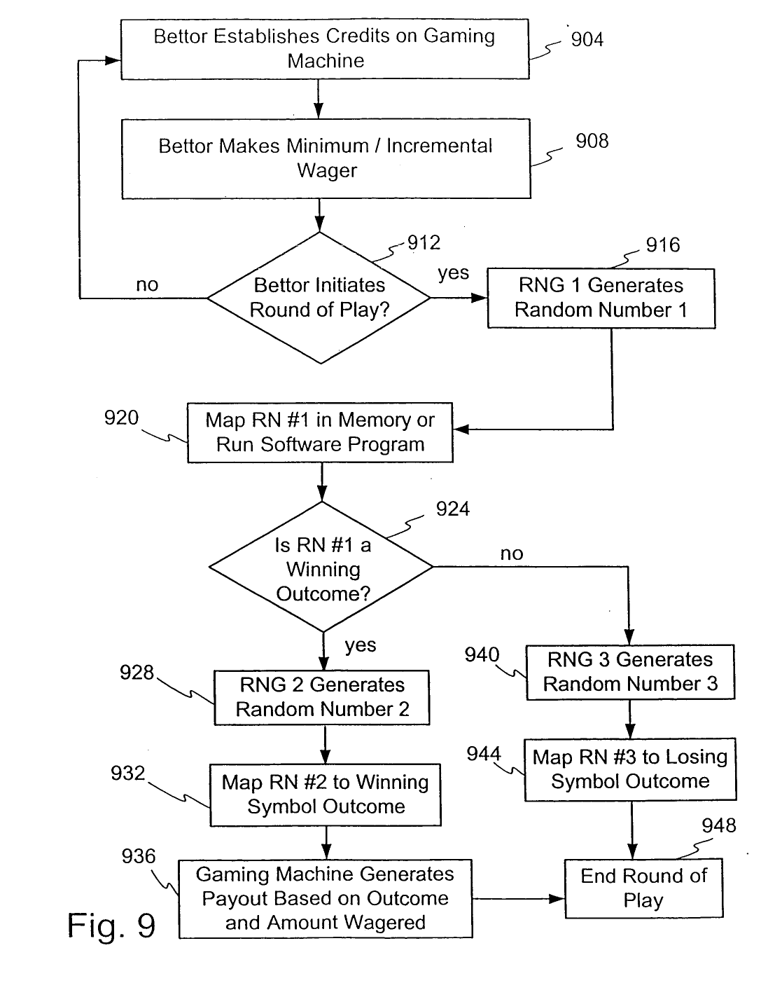

FIG. 9 provides an operational flow diagram of the embodiment shown in FIG. 7. In a step 904, a player makes a minimum wager by either pressing a single bet button or by inserting a coin or token. In a step 908, a coin/token sensor registers the coin or token deposited into the gaming machine and credits the monies toward the next game. In a step 912, the player makes a decision to initiate the round of play or to allocate an incremental amount to the wager. Should the player make a decision to initiate the round of play by pulling the handle or pressing the spin button at the time a bet is wagered, the processor causes the first random number generator to generate a random number as shown in a step 916. The random number generator may be configured to generate integers starting at 1 and ending at an exemplary 100, as was illustrated in FIG. 8A. It is contemplated that the random number may be generated from any range of numbers as determined and configured by the gaming machine operator. In a step 920, the first random number is mapped in win/lose memory, resulting in either a win outcome or a lose outcome. The probability of winning may be a function of the amount wagered. In a step 924, if the first random number maps to a lose outcome, the process proceeds to a step 940, where a third random number generator generates a third random number. The random number generator may be configured to generate integers starting at 1 and ending at an exemplary 100, as was illustrated in FIG. 8C. Again, the range of numbers may be configured on the gaming machine based on the gaming machine operator's preferences. In a step 944, the third random number is mapped to a specific losing symbol outcome and displayed to the bettor. Then, the round of play ends as indicated in a step 948.

Should the first random number be mapped to a win outcome, the process continues at a step 928, in which a second random number generator generates a second random number. The random number generator may be configured to generate integers starting at 1 and ending at an exemplary 50, as was illustrated in FIG. 8B. In a step 932, the second random number is mapped to a corresponding symbolic winning outcome. For example, the symbol outcome may comprise three cherries (Ch, Ch, Ch) corresponding to the random number 44. It is contemplated that the random numbers generated may be chosen to be any set of numbers that may be used to represent the desired winning outcomes. In a step 936, the gaming machine may generate an appropriate payout as a function of the amount wagered. It is contemplated that this step may be performed based on the preferences of the gaming machine operator. The gaming machine operator may chose to provide typical payout rates proportional to the amount wagered. In other instances, the gaming machine operator may configure the payout memories at payout rates that increase non-linearly as the minimum bet is increased as an incentive to a player to maximize a bet per round of play. The gaming machine dispenses or credits the payout, and the round of play terminates in a step 940.

A variety of alternate configurations of apparatus and methods are contemplated other than those specifically described herein.

As indicated, in one embodiment of a method, the probability of receiving a winning outcome varies depending upon the size of a bet placed by a player of a gaming machine. In a preferred embodiment, the probability of receiving a winning outcome increases as bet size increases. As described above, in one embodiment, this method may be implemented by causing one or more outcomes which are defined as losing outcomes for a bet of a first size to be configured as winning outcomes if received when a bet of a second (and preferably larger) bet is placed. In other words, the probability of receiving a winning outcome increases because the number of possible winning combinations increases as compared to losing combinations as bet size changes. For example, as illustrated in FIG. 3B compared to FIG. 3A, three new winning combinations have been defined.

In another configuration, this method may be implemented by causing the probability of a particular winning combination or outcome to occur more frequently. For example, though not illustrated in FIG. 3B, the outcome table illustrated therein could be modified so that the combination TR, TR, TR may be received when random number 1 or 100 occurs. In this manner, the odds of receiving this particular winning combination are doubled.

As described, this embodiment method of the invention may be implemented in a variety of ways. In one embodiment, the method is implemented in a gaming machine by including multiple “look-up” tables which are stored in one or more memory units. The method may be implemented using other systems or apparatus.

It will be appreciated that the probability of receiving a winning outcome need not increase specifically for each bet increment (i.e., x, 2×, 3×). For example, the probabilities may vary for ranges of bets or only particular different bets. In one embodiment, the probability for receiving a winning outcome may be the same for all amounts wagered except a maximum permitted wager, in which case the probability of receiving a winning outcome may be increased for that maximum wager.

This embodiment of the invention has numerous advantages. In this embodiment, it is possible to increase the probability that a player will receive a winning combination as the size of a player's bet increases. In other words, for the play of a given game or round of game play, the player is more likely to receive a winning outcome if he or she places a larger bet than if the player places a smaller bet. A player is enticed to bet a larger or maximum bet, as this increases the odds that the player will receive a winning combination. In one embodiment, the average “hold” for the gaming machine always remains at least several percent of the total amounts wagered. Thus, as players place larger wagers, the total amounts wagered during a period of time, and thus the total net revenue to the casino, increases.

In another embodiment of the invention, as described, the size of the average payout per minimum wager varies as bet size changes. In one version or variation, the average payout for one or more particular winning combinations varies as bet size changes. Preferably, the size of the average payout per minimum wager increases as bet size increases for a specific winning outcome. In particular, the size of the average payout increases more than the percentage by which the bet size increases. This is a significant advantage over the prior art. In the prior art, the payout increases proportionately with bet size (i.e., if the bet is 2 credits versus 1, then the payout for a winning combination is 2 times the payout compared to when a single bet is placed). In accordance with the invention, the payout increases disproportionately to the percentage change in bet, being greater (or less, if desired) than this percentage change.

As also described above, in one embodiment, the average payout or return varies with bet size. Preferably, the average payout or return increases with bet size. For example, the average return or payout may be 97% when bets of a second amount are placed, as compared to 95% when bets of a first, smaller amount are placed. In other words, the payout to the player increases, on average, 2% when the player places a larger, second bet. This embodiment has the advantage that a player placing larger bets will receive, on average, a higher return.

As described above, in one embodiment, an increase in the size of the average payout comprises increasing the payout multiplier for all winning combinations as bet size increases. The method may be implemented in other fashions, however. For example, the payout for one or some, but not all, winning combinations may be increased. In addition, the amount of the increase may vary, depending on the specific outcome.

Once again, the methods may be implemented in a variety of fashions. As described, for example, a method may be implemented by using a plurality of “look-up” tables having varied payouts. In another embodiment, a single look-up table may be used. Based on the size of the bet, a constant multiplier may be applied to each winning payout. The multiplier may increase (preferably) or decrease as the bet size increases.

This method, likewise, has numerous advantages. Once again, a player is enticed to bet a larger or maximum bet, as such results in the likelihood that the player will receive a larger payout. Because the player is enticed to wager larger amounts, the total revenue for the casino may also increase.

It will be understood that the above described arrangements of apparatus and the method therefrom are merely illustrative of applications of the principles of this invention and many other embodiments and modifications may be made without departing from the spirit and scope of the invention as defined in the claims.

What is claimed is:

1. A method of playing a game on a gaming machine in which the probability of receiving a winning outcome varies dependent upon an amount wagered, comprising the steps of:
accepting a wager from a player;
determining if said wager is a first amount or a second amount, said second amount being larger than said first amount;
presenting a game for play by said player, said game having a first probability of resulting in a winning outcome if said wager is said first amount, and said game having a second probability of resulting in a winning outcome if said wager is said second amount;
determining the outcome of said game; and
awarding said player a winning if said outcome is a winning outcome.
